(19) United States
(12) Patent Application Publication
(10) Pub. No.: US 2019/0275973 A1
(43) Pub. Date: Sep. 12, 2019

(54) METHOD FOR DETECTING MISUSE OF A SAFETY BELT AND SAFETY BELT SYSTEM

(71) Applicant: ZF Friedrichshafen AG, Friedrichshafen (DE)

(72) Inventors: Christoph Göring, Ravensburg (DE); Daniel Widmann, Eriskirch (DE)

(73) Assignee: ZF Friedrichshafen AG, Friedrichshafen (DE)

(21) Appl. No.: 16/288,708

(22) Filed: Feb. 28, 2019

(30) Foreign Application Priority Data
Mar. 12, 2018 (DE) 102018203683.7

(51) Int. Cl. B60R 21/015; G06N 3/04; B60W 40/10

(52) U.S. Cl. CPC B60R 21/01544; B60R 2022/4816; B60W 40/10; G06N 3/049

(57) ABSTRACT

A method for detecting misuse of a safety belt in a vehicle by a control unit (12) of the vehicle, comprising the following steps:
a) recording vehicle parameters (P),
b) supplying the vehicle parameters (P) to an artificial neural network (40);
c) recording the at least one output value (A) of the artificial neural network (40), and
d) detection of whether or not there is a misuse of the safety belt based on the output value (A).

There is also a safety belt system (10) for a vehicle.

### FIELD

The invention relates to a method for detecting misuse of a safety belt and a safety belt system.

### DESCRIPTION OF RELATED ART

In many countries, a safety belt must be worn when driving. Although it has been proven that the use of a safety belt significantly increases the safety of the occupants of a vehicle, safety belt systems are nevertheless misused intentionally, in that the safety belt is not worn. By way of example, an occupant may insert the latch plate into the buckle, and then sit on the safety belt. In order to circumvent safety belt buckle sensors, separate latch plates that are not connected to the safety belt are also inserted in the belt buckle. The sensor signals alone do not provide reliable information regarding whether the safety belt is being misused or not.

For this reason, WO 2016/116264 proposes the linking of various sensor signals, because it can be determined from the temporal sequence of the sensor signals whether the safety belt is being misused or not. Various temporal sequences are stored in a control unit for this, which are either associated with correct use or with misuse. These result in rigid systems, however, because the control unit can only evaluate those situations and sequences that have already been stored.

### SUMMARY

It is therefore the object of the invention to create a method for detecting misuse of a safety belt in a vehicle, and a safety belt system, which can also correctly analyze unfamiliar situations with high probability.

This object is achieved by a method for detecting misuse of a safety belt in a vehicle by a control unit in the vehicle, which has the following steps:
a) recording vehicle parameters,
b) transmitting the vehicle parameters to an artificial neural network,
c) recording the at least one output value of the artificial neural network, and
d) determining on the basis of the output value whether the safety belt is being misused or not.

The artificial neural network is trained to distinguish between a misuse of the safety belt and a correct use of the safety belt.

By using an artificial neural network, it is no longer necessary to anticipate every possible situation and sequence of sensor signals, and to store this information in the control unit. Instead, it is sufficient to train the artificial neural network with a broad range of possible misuses, because the artificial neural network can then also analyze such situations that have not been explicitly taught with greater reliability. As a result, the detection of misuse is more flexible, and more difficult to circumvent.

The artificial neural network is part of the control unit, for example, and thus stored in the control unit.

By way of example, a misuse of the safety belt is detected when the output value of the artificial neural network for a specific time frame lies below or above a specific threshold value or a threshold value range, in order to prevent misjudgments due to briefly falling below the threshold value or the threshold value range.

The vehicle parameters are preferably recorded on at regular intervals, in particular with a sampling rate of 100 Hz, and/or the vehicle parameters are transmitted to the artificial neural network at regular intervals. As a result, misuses can also be detected that occur while driving, e.g. when an occupant unbuckles.

In order to improve the precision of the detection, at least one temporal sequence of the vehicle parameters of a predetermined length can be recorded and the sequence can be transmitted to the artificial neural network. The sequence can contain 32 samples, for example, relating to measurement values of each of the vehicle parameters. The sequences can be recorded on a permanent basis, and supplied continuously to the artificial neural network.

In one embodiment, the vehicle parameters comprise the longitudinal acceleration of the vehicle, the transverse acceleration of the vehicle, the speed of the vehicle, the steering angle, the brake pressure, the extension of the safety belt, the occupancy of the seats, and/or the states of the safety belt buckles, by means of which it is possible to precisely detect any misuse.

By way of example, a warning signal is issued, or a measure is taken when it has been determined that a safety belt is being misused, in order to alert the driver to the misuse, and to indicate the correct use of the safety belt.

One measure could conceivably be a reduction in the maximum speed of the vehicle, or even a blocking of use of the vehicle, such that the motor of the vehicle cannot be started.

In one embodiment of the invention, the artificial neural network is at least in part a recurrent neural network, by means of which the temporal course of the signals is incorporated in the analysis, thus increasing the precision.

The artificial neural network preferably comprises at least one long short-term memory layer; in particular, at least three consecutive long short-term memory layers are provided. In this manner, temporal changes in the vehicle parameters can be taken into consideration in the analysis. The long short-term memory layer contains 32 neurons, for example.

By way of example, at least one fully linked layer adjoins the at least one long short-term memory layer, by means of which the output value can be determined with greater precision.

The fully linked layer can have 32 neurons. The fully linked layer forms the output layer of the artificial neural network, for example.

In one embodiment of the invention, the output value, in particular the output value of the at least one fully linked layer is a scalar that can preferably assume values in intervals [0, 1], enabling a simple evaluation of the output value.

In another embodiment of the invention, the artificial neural network is at least in part a convolutional neural network. This enables the artificial neural network to process time intervals or sequences of arbitrary sizes.

By way of example, the convolutional neural network does not have a fully linked layer.

The convolutional neural network preferably has at least one convolutional layer for detecting patterns in the vehicle parameters.

In order to simplify the architecture of the artificial neural network, the convolutional neural network can have at least one sub-network. There can also be numerous consecutive identical sub-networks.

The at least one sub-network preferably has at least one of the at least one convolutional layers, a first pooling layer, in particular adjoining the convolutional layer, and/or a second pooling layer, in particular parallel to the convolutional layer and/or the first pooling layer. As a result, the precision can be further increased for the determination of misuse.

The size of the core of the convolutional layer can be 3, that of the first pooling layer can be 2, and/or that of the second pooling layer can be 2.

By way of example, the first pooling layer is maximum pooling layer and/or the second pooling layer determines the mean.

In order to simplify the data processing, the output of the second pooling layer and the output of the convolutional layer or the first pooling layer can be combined.

By way of example, the sub-network has a further convolutional layer, wherein the combined outputs are supplied to the further convolutional layer in order to further increase the precision.

The core size of the further convolutional layer can be 1, and/or the activation function can be an exponential linear unit (ELU).

In one embodiment variation, the convolutional neural network has a reduction layer, which outputs a single value in order to make a statement regarding the entire temporal range of the sequence supplied to the artificial neural network. The reduction layer determines the mean, for example, of the data supplied to it. This one value can be the output value.

For a simple evaluation of the value, the value of the reduction layer can be plotted by a function, in particular a sigmoid function at the interval [0, 1]; in particular, the value forms the output value.

The reduction layer preferably follows the last sub-network.

The object is also achieved by a safety belt system for a vehicle with a safety belt and a control unit, which is configured to execute the method according to the invention, in particular wherein the control unit contains the artificial neural network.

### BRIEF DESCRIPTION OF THE DRAWINGS

Further features and advantages of the invention can be derived from the following description and the attached drawings, to which reference shall be made. Therein:

FIG. 1 shows a schematic illustration of a safety belt system according to the invention,

FIG. 2 shows a schematic illustration of a first embodiment of an artificial neural network according to FIG. 1, for executing the method according to the invention,

FIG. 3 shows a second embodiment of an artificial neural network according to FIG. 1, for executing the method according to the invention,

FIG. 4 shows a detail of a sub-network of the artificial neural network according to FIG. 3,

### DETAILED DESCRIPTION

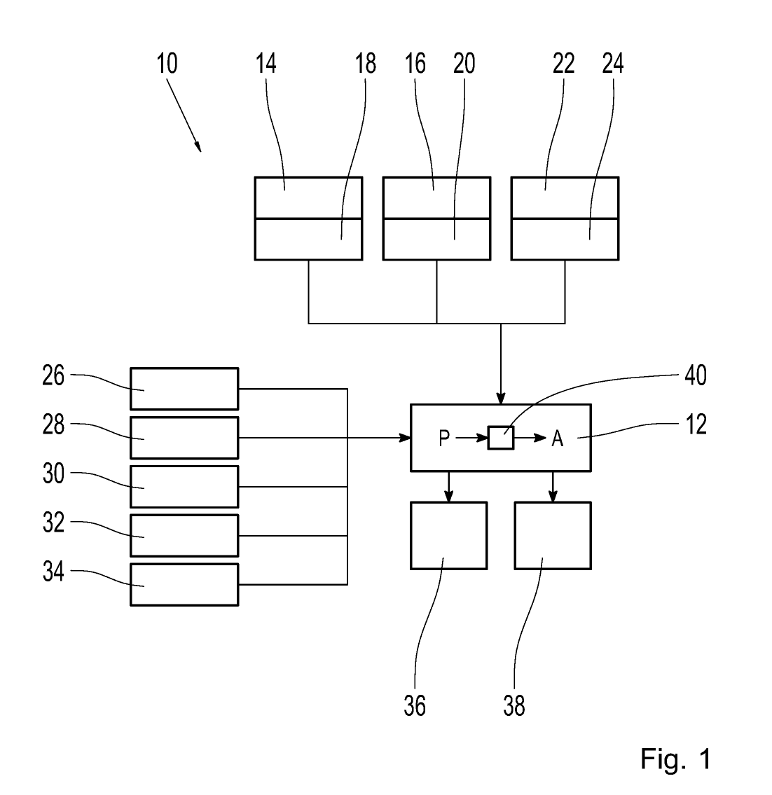

FIG. 1 shows a schematic illustration of a safety belt system 10 for a vehicle, not shown.

The safety belt system comprises a control unit 12 and numerous safety belts (not shown), the concrete use of which can be determined by the control unit 12.

The vehicle normally has a separate safety belt for each seat, with the corresponding components, wherein for purposes of simplicity, a safety belt system 10 with only one safety belt shall be described below, merely by way of example. The example can obviously be expanded to safety belt systems 10 with numerous safety belts, e.g. for the driver and front passenger seat, and/or rear seats.

The safety belt system 10 has a belt buckle 14 and a seatbelt retractor 16. The belt buckle 14 has a buckle sensor 18, which can detect the insertion and removal of a latch plate of the safety belt.

The buckle sensor 18 can therefore generate a signal indicating whether a latch plate is inserted in the belt buckle 14 or not. The buckle sensor 18 can transmit this signal to the control unit 12 via an appropriate connection, e.g. an electrical or wireless connection.

In a similar manner, the seatbelt retractor 16 has a seatbelt extension sensor 20, which is likewise connected to the control unit 12 for electrical or wireless signal transmission.

The seatbelt extension sensor 20 registers seatbelt movements in both the positive and negative direction of extension. The movement direction and the length of the seatbelt extension are transmitted to the control unit 12.

In the exemplary embodiment shown therein, there is also a vehicle seat 22 with a seat occupancy sensor 24, which is likewise connected to the control unit 12.

The seat occupancy sensor 24 can detect whether or not the vehicle seat 22 is occupied, and transmits the occupancy state of the vehicle seat 22 to the control unit 12 via an electrical or wireless connection.

A seat occupancy sensor 24 is provided in particular for the front passenger seat, but can also be provided for other seats in the vehicle.

Furthermore, the vehicle has an acceleration sensor 26 for longitudinal accelerations, an acceleration sensor 28 for transverse accelerations, a speed sensor 30, a brake sensor 32, and a steering angle sensor 34, all of which are likewise connected to the control unit 12 for signal transmission via an electrical or wireless connection.

The acceleration sensor 26 for longitudinal accelerations transmits the longitudinal accelerations of the vehicle to the control unit 12, the acceleration sensor 28 for transverse accelerations transmits the transverse accelerations of the vehicle to the control unit 12, the speed sensor 30 transmits the speed of the vehicle to the control unit 12, the braking sensor 32 transmits the brake pressure of the vehicle to the control unit 12, and the steering angle sensor 34 transmits the steering angle of the vehicle to the control unit 12.

For illustrative purposes, an individual sensor has been described for each of these vehicle parameters P, but as a matter of course, an individual sensor is not necessary for each of these vehicle parameters P. Many of these vehicle parameters P are present or known in the central motor control system (not shown), and can thus be transmitted from the central motor control system to the control unit 12, without needing a separate sensor.

It is also conceivable, as a matter of course, that the control unit 12 is a part of the central motor control system, or vehicle control system.

The control unit 12 comprises an artificial neural network 40 for processing the vehicle parameters P and for determining whether there has been a misuse of the safety belt.

The artificial neural network 40 of the control unit 12 has been trained to distinguish misuses of the safety belt from correct uses thereof.

For the output, the control unit 12 is connected to an output device 36, e.g. a loudspeaker and/or a display, and a so-called SBI system 38.

The SBI system (seatbelt interlock) can implement measures for improving the driving safety, e.g. limiting the maximum speed of the vehicle, or even preventing operation of the vehicle.

In order to detect misuse of the safety belt, i.e. to detect whether the safety belt has been correctly placed on the body and is latched in the belt buckle, the control unit 12 records various vehicle parameters P, or all of the vehicle parameters P provided by the sensors 18, 20, 24, 26, 28, 30, 32 and 34.

The control unit 12 thus receives various vehicle parameters P. In the exemplary embodiment shown therein, these are the longitudinal acceleration of the vehicle, the transverse acceleration of the vehicle, the speed of the vehicle, the steering angle, the brake pressure, the seatbelt extension (direction, speed and/or length), the seat occupancy, and/or the belt buckle state (buckled or not).

The control unit 12 records the vehicle parameters P at a sampling rate, e.g., of 100 Hz.

The recorded vehicle parameters P are subsequently subdivided into temporal sequences with a predetermined duration. By way of example, the temporal sequences are 3.2 seconds.

In order to reduce the complexity of the method, the vehicle parameters P can be subjected to a sub-sampling of 10 Hz. In this case, each temporal sequence contains 32 samples, i.e. measurement values, of each vehicle parameter P.

These temporal sequences are then transmitted to the artificial neural network 40, the artificial neural network 40 calculates an output value A, and the output value A is evaluated by the control unit 12.

For illustrative purposes, a distinction is made in the framework of this invention between the artificial neural network 40 of the control unit 12 and the other functions of the control unit 12. The other functions are referred to as “the control unit,” even though the artificial neural network 40 is likewise part of the control unit 12. It should be clear through this formulation that method steps take place in the known manner prior to and after the processing of the data by the artificial neural network 40.

Because a continuous determination of the vehicle parameters P takes place, thus a determination at regular intervals at a rate of less than one second, the vehicle parameters P are transmitted at the same rate to the artificial neural network 50, and the output value A of the artificial neural network 50 is also updated at this rate.

Based on the output value A, the control unit 12 can determined at the same rate whether the safety belt is being misused or not.

For this, the output value A is compared with a specific threshold value or a threshold value range.

By way of example, possible output values lie within a closed interval of 0 to 1 (i.e. [0, 1]) and the threshold value is 0.5. In this case, output values of less than 0.5 are regarded as indicating a misuse, and output values of greater than or equal to 0.5 indicate a correct use of the safety belt.

In order to avoid false warnings, it is preferably provided that a misuse is first detected, or measures are first taken, when the output value of the artificial neural network 40 lies below or above the threshold value or threshold value range for a predetermined time period, e.g. 2 seconds.

If the control unit 12 determines that there has been a misuse, it generates a warning signal by means of the output device 36.

This can be a warning sound or a speech output by a loudspeaker and/or a visual indication on a display, or a lighting up of the display.

Alternatively or additionally, the control unit 12 can take appropriate measures via the SBI system 38 or a similar system, e.g. limiting the maximum speed of the vehicle, or deactivation of the vehicle.

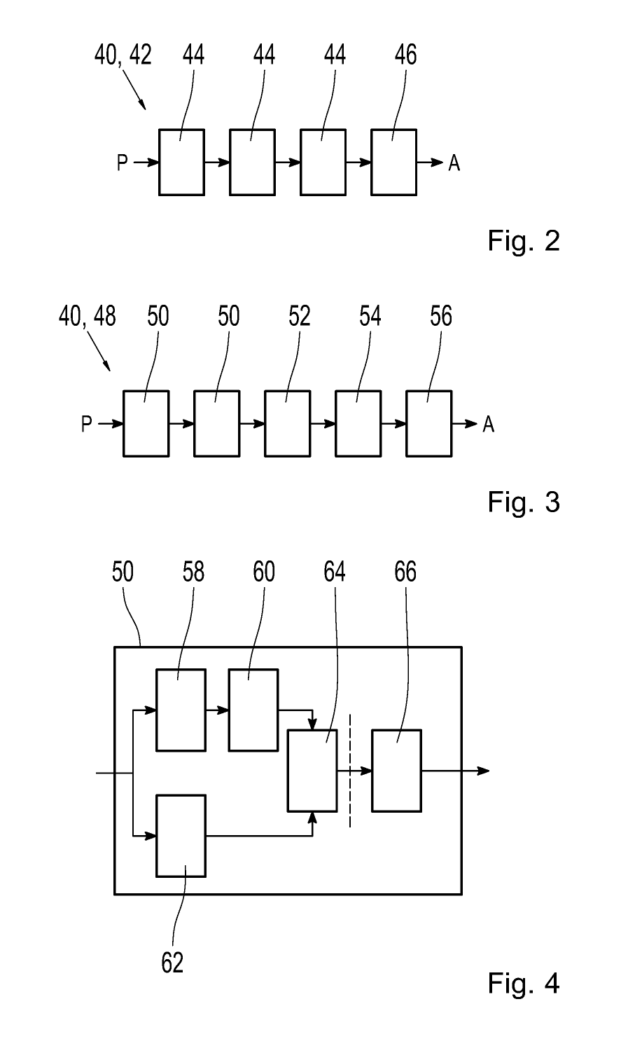

The first embodiment of the artificial neural network 40 shown in FIG. 2 is the artificial neural network 50 of a recurrent neural network 42.

The recurrent neural network 52 has three long short-term memory layers 44 (LTSM), disposed consecutively, wherein the first long short-term memory layer 44 receives the vehicle parameters P from the control unit 12.

Other numbers of long short-term memory layers 44 are also conceivable, as a matter of course.

A fully linked layer with 32 neurons adjoins the last long short-term memory layer 44, which forms the output layer and outputs the output value A.

Numerous fully linked layers 46 can also be provided, of course.

The fully linked layer 46 is configured such that the output value A lies within a closed interval of 0 to 1 (interval [0, 1]), wherein the value 1 corresponds to a correct use of the safety belt and the value 0 corresponds to a misuse of the safety belt.

If the output value A assumes values between 0 and 1, this means that it cannot be safely stated on the basis of the measured vehicle parameters P whether there is a misuse or correct use at this moment. The value only indicates a probability in this case.

The output value A is therefore the output value of the recurrent neural network 52, and thus of the artificial neural network 40.

A second embodiment of the artificial neural network 40 is illustrated in FIGS. 3 and 4. Only the differences to the first embodiment shall be discussed below. The remaining functionalities and components are identical.

In this second embodiment, the artificial neural network 40 is a convolutional neural network 48.

The convolutional neural network 48 in the exemplary embodiment shown therein does not have a fully linked layer.

As can be seen in FIG. 3, the convolutional neural network 48 has two sub-networks 50, which are shown in FIG. 4.

The vehicle parameters P are supplied to the first sub-network 50.

A convolutional layer 52 adjoins the last sub-network 50, followed by a reduction layer 54 and subsequently a function, in this case a sigmoid function 56, which outputs the output value A.

The sub-networks 50 are identical, and there can also be further sub-networks. This is indicated by the broken-line arrow in FIG. 3.

The sub-networks 50 have two separate and parallel branches at the start.

A convolutional layer 58 is present in one branch, to which a first pooling layer 60 is connected. The convolutional layer 58 has a core size of 3, for example.

The first pooling layer 60 is a maximum pooling layer and has a core size of 2 and a stride of 2, for example.

There is just one pooling layer 62 in the second branch. The second pooling layer 62 is an averaging pooling layer, and has a core size of 2, for example.

The outputs of the first pooling layer 60 and the second pooling layer 62 are combined in a layer 64.

In the exemplary embodiment shown therein, a 30% drop-out is subsequently carried out, before a subsequent convolutional layer 66 with a core size of 1 is provided.

The final convolutional layer 66 forms the end of the sub-network 50.

The activation function of the convolutional layers 52, 58, and 66 is an exponential linear unit (ELU) for example.

The outputs of the last sub-network 50 are supplied to the convolutional layer 52, which, with a core size of 1, generates a single feature map, which is supplied to the reduction layer 54.

The reduction layer 54 calculates the mean of the values output by the convolutional layer 52.

Because the output of the convolutional layer 52 comprises one value per time interval, or sampling of the input data, the reduction layer 54 depicts a simple averaging over time.

The subsequent sigmoid function 56 then maps the average obtained from the reduction layer 54 in the closed interval of 0 to 1.

The output value of the sigmoid function 56 is then the output value A of the convolutional neural network 48, and thus the artificial neural network 40.

It is also conceivable that each individual time interval or sample is separately supplied to the control unit 12 as an output value A.

The two examples of the artificial neural network 40 shown herein are only to be regarded as exemplary.

As a matter of course, these neural networks, or parts thereof, can be combined with one another.

### REFERENCE SYMBOLS

10 safety belt system
12 control unit
14 belt buckle
16 seatbelt retractor
18 belt buckle sensor
20 belt extension sensor
22 vehicle seat
24 seat occupancy sensor
26 acceleration sensor for longitudinal accelerations
28 acceleration sensor for transverse accelerations
30 speed sensor
32 brake pressure sensor
34 steering angle sensor
36 output device
38 SBI system
40 artificial neural network
42 recurrent neural network
44 long sort-term memory layer (LSTM)
46 fully linked layer
48 convolutional neural network
50 sub-network
52 convolutional layer
54 reduction layer
56 sigmoid function
58 convolutional layer
60 first pooling layer
62 second pooling layer
64 layer
66 final pooling layer
P vehicle parameters
A output value

1. A method for detecting misuse of a safety belt in a vehicle by a control unit of the vehicle, comprising the following steps:
a) recording vehicle parameters (P),
b) supplying the vehicle parameters (P) to an artificial neural network;
c) recording the at least one output value (A) of the artificial neural network, and
d) detection of whether or not there is a misuse of the safety belt based on the output value (A).

2. The method according to claim 1, characterized in that a misuse of the safety belt is detected when the output value (A) of the artificial neural network lies below or above a specific threshold value or threshold value range for a specific time period.

3. The method according to claim 1, characterized in that the vehicle parameters (P) are recorded at regular intervals, in particular with a sampling rate of 100 Hz, and/or the vehicle parameters (P) are supplied at regular intervals to the artificial neural network.

4. The method according to claim 1, characterized in that at least one temporal sequence of the vehicle parameters (P) is recorded for a predetermined time, and the sequence is supplied to the artificial neural network.

5. The method according to claim 1, characterized in that the vehicle parameters (P) comprise the longitudinal acceleration of the vehicle, the transverse acceleration of the vehicle, the speed of the vehicle, the steering angle, the brake pressure, the seatbelt extension, the seat occupancy, and/or the belt buckle state.

6. The method according to claim 1, characterized in that the artificial neural network is at least in part a recurrent neural network.

7. The method according to claim 6, characterized in that the artificial neural network comprises at least one long short-term memory layer, in particular wherein there are at least three successive long short-term memory layers.

8. The method according to claim 7, characterized in that at least one fully linked layer adjoins the at least one long short-term memory layer.

9. The method according to claim 1, characterized in that the artificial neural network is at least in part a convolutional neural network.

10. The method according to claim 9, characterized in that the convolutional neural network comprises at least one convolutional layer.

11. The method according to claim 9, characterized in that the convolutional neural network comprises at least one sub-network.

12. The method according to claim 11, characterized in that the at least one sub-network comprises at least one of the at least one convolutional layers, a first pooling layer, in particular adjoining the convolutional layer, and/or a second pooling layer, in particular wherein the second pooling layer is parallel to the convolutional layer an/or the first pooling layer.

13. The method according to claim 12, characterized in that the output of the second pooling layer and the output of the convolutional layer or the first pooling layer are combined.

14. The method according to claim 9, characterized in that the convolutional neural network has a reduction layer that outputs a single value.

15. A safety belt system for a vehicle with a safety belt and a control unit, which is configured to execute a method according to claim 1, in particular wherein the control unit comprises the artificial neural network.

16. The method according to claim 2, characterized in that the vehicle parameters (P) are recorded at regular intervals, in particular with a sampling rate of 100 Hz, and/or the vehicle parameters (P) are supplied at regular intervals to the artificial neural network.

17. The method according to claim 2, characterized in that at least one temporal sequence of the vehicle parameters (P) is recorded for a predetermined time, and the sequence is supplied to the artificial neural network.

18. The method according to claim 2, characterized in that the vehicle parameters (P) comprise the longitudinal acceleration of the vehicle, the transverse acceleration of the vehicle, the speed of the vehicle, the steering angle, the brake pressure, the seatbelt extension, the seat occupancy, and/or the belt buckle state.

19. The method according to claim 2, characterized in that the artificial neural network is at least in part a recurrent neural network.

20. The method according to claim 2, characterized in that the artificial neural network is at least in part a convolutional neural network.
